(19) United States
(12) Patent Application Publication
(10) Pub. No.: US 2006/0234574 A1
(43) Pub. Date: Oct. 19, 2006

(54) Floor covering product and method of making same

(76) Inventors: Larry Mullinax, Cartersville, GA (US); L. Jay Taylor, Acworth, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/394,638

(22) Filed: Mar. 31, 2006

Related U.S. Application Data
(60) Provisional application No. 60/667,371, filed on Mar. 31, 2005.

(51) Int. Cl. B32B 5/02; D03D 27/00; D05C 17/00; B32B 27/04

(52) U.S. Cl. 442/101; 428/95; 428/96

(57) ABSTRACT

The invention comprises a floor covering that can be washed and dried in conventional residential washing and drying equipment. The floor covering comprises a textile material and a non-skid thermoplastic coating on a surface of the textile material. The non-skid, thermoplastic polymer coating is washable and dryable at temperatures up to approximately 200° F. A method of making the floor covering is also disclosed.

### CROSS-REFERENCE TO RELATED APPLICATIONS

This application claims the benefit of provisional application Ser. No. 60/667,371, filed Mar. 31, 2005.

### FIELD OF THE INVENTION

The present invention generally relates to textile floor covering materials. More particularly, this invention relates to floor covering materials used as bath mats or scatter rugs having a backing with improved properties, such that the floor covering is washable and dryable in conventional residential washing and drying machines.

### BACKGROUND OF THE INVENTION

Floor covering materials, such as bath mats and scatter rugs, are used as functional design elements in homes around the world. Bath mats and scatter rugs typically include a backing material having non-skid properties to hold the bath mat or scatter rug in place on the floor and to prevent a consumer from injuries resulting from a fall caused by the bath mat or scatter rug slipping on the underlying flooring material. However, current non-skid backings on bath mats and scatter rugs typically contain surfactants, tackifiers and/or plasticizers that can migrate to the surface of the backing and potentially stain or discolor the flooring material upon which the bath mat or scatter rug is placed. Furthermore, as these surfactants, tackifiers and/or plasticizers are lost from the backing, the non-skid backing may become brittle and/or degrade. When this happens, the face fibers may become loose thereby rendering the bath mat or scatter rug undesirable for its intended purpose and usually resulting in the bath mat or scatter rug being discarded. Typically, such bath mats or scatter rugs are discarded with residential household garbage thereby introducing the discarded bath mats or scatter rugs into a community's landfill or garbage dump. Thus, current bath mats and scatter rugs contribute to the overburdening of landfills or garbage dumps and to the pollution of the environment.

There is a general desire in today's society to recycle products so that they can be used a second time instead of manufactured once and discarded. What is needed, therefore, is a floor covering material, such as a bath mat or a scatter rug, which is made from materials that can be recycled.

### SUMMARY OF THE INVENTION

The present invention satisfies the foregoing need by providing a thermoplastic polymer-backed floor covering, such as a bath mat or a scatter rug, which is washable and dryable in conventional residential washing and drying equipment. The present invention comprises a floor covering product comprising a textile material and a non-skid, thermoplastic polymer coating on a surface of the textile material. The non-skid, thermoplastic polymer has a softening temperature of greater than approximately 200° F.

In another aspect, the present invention provides a method of making a thermoplastic polymer-backed floor covering, such as a bath mat or a scatter rug, which is washable and dryable in conventional residential washing and drying equipment. The method comprises applying to a surface of a textile material a non-skid, thermoplastic polymer. The non-skid, thermoplastic polymer is applied directly to the textile material in a molten state. Pressure is then applied to said textile material and molten non-skid, thermoplastic polymer on the textile material, so that the molten non-skid, thermoplastic polymer adheres to the textile material. The non-skid, thermoplastic polymer coating has a softening temperature of greater than approximately 200° F.

Accordingly, it is an object of the present invention to provide an improved floor covering product, such as a bath mat or a scatter rug.

Another object of the present invention is to provide a floor covering product that utilizes recyclable materials.

Still another object of the present invention is to provide a floor covering product that is resistant to heat, such as would be encountered in typical residential laundry machines and drying machines.

Still another object of the present invention is to provide a floor covering product having a backing that has one or more, preferably all, of the following properties: non-skid, non-discoloring, non-flammable, odorless, dye resistant, increased tuft lock and bundle wrap, washable, water-resistant, aesthetically attractive, embossable, plasticizer migration resistant, non-staining, oxidation resistant, non-brittle, non-powdering, quick drying, mildew resistant, and recyclable.

These and other objects, features and advantages of the present invention will become apparent upon reviewing the following detailed description of the disclosed embodiments and the appended drawing and claims.

### BRIEF DESCRIPTION OF THE DRAWINGS

FIG. 1 is a cross-sectional side view of a disclosed embodiment of a floor covering in accordance with to the present invention.

FIG. 2 is a side schematic view of an apparatus for manufacturing floor covering according to the present invention.

### DETAILED DESCRIPTION OF THE DISCLOSED EMBODIMENTS

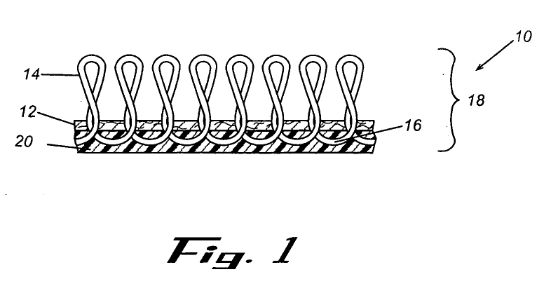

With reference to the drawing in which like numbers indicate like elements throughout the several views, it will be seen that there is disclosed a floor covering product 10 (FIG. 1), such as a bath mat or a scatter rug, in accordance with the present invention. The floor covering product 10 comprises a primary backing material 12 through which loops of yarn are tufted in order to form a face pile 14 on one side of the primary backing material. The face pile 14 may be looped, as shown in FIG. 1, or it may be cut (not shown). The yarn forming the face pile 14 can be any suitable fiber, or blend of fibers, typically used in bath mats or scatter rugs, including, but not limited to, nylons; polyolefins, such as polypropylenes and polyethylenes; polyesters or combinations thereof and natural fibers, such as cotton. The primary backing material 12 can be made from any synthetic or natural material suitable for tufting, including, but not limited to, polyester, polypropylene, polyethylene, nylon, fiberglass or combinations thereof.

Collectively, the face pile 14, the primary carpet backing 12 and the loop backs 16 form a facing layer 18. While the facing layer 18 of the floor covering product 10 has been illustrated in FIG. 1 as a tufted product, the facing layer can be of any desired construction and composition. Such facing layer 18 can comprise, for example, a knitted, woven, or nonwoven textile product of natural or synthetic materials. The facing layer 18 advantageously has a weight of about 0.9 to about 85 ounces per square yard; preferably, about 2 to 80 ounces per square yard.

With reference to FIG. 1, the floor covering product 10 further comprises a layer of a non-skid, thermoplastic polymer 20. The non-skid, thermoplastic polymer layer 20 is formed on the side of the primary backing 12 opposite the face pile 14. The thermoplastic polymer layer 20 also contacts the loop backs 16 securing them to the primary backing 12. Alternately, in the case of knitted, woven or nonwoven facing layers, the non-skid polymer layer 20 is adhered to the back surface of the facing layer 18. The non-skid polymer layer 20 is applied to the back surface of the facing layer 18 in amounts of approximately 5 to 50 ounces per square yard.

The non-skid polymer layer 20 comprises the composition disclosed in U.S. patent application Ser. No. 10/928,348 filed Aug. 27, 2004, the disclosure of which is incorporated herein by reference. The non-skid polymer layer 20 preferably comprises a mixture of a thermoplastic polymer and a flexibilizer. The thermoplastic polymer can be any polymer that softens when heated and hardens when cooled and will adhere or bind to the primary backing 12, or the back surface of the facing layer 18, and includes, but is not limited to, thermoplastic polyolefins, such as polypropylene, low-density polyethylene and high-density polyethylene; thermoplastic polyurethanes; ethylene propylene diene monomer (“EPDM”) rubber; and mixtures thereof. The non-skid polymer layer 20 can be in the form of a solid elastomeric coating or a foam cushion coating. The non-skid polymer layer 20 is applied to the primary backing 12 in a molten form and is then formed into a layer of a desired thickness on the primary backing, such as by doctoring, using a hot knife or by passing the coated textile material between a pair of heated nip rollers to press the resin into the fibers on the back of the textile material; e.g., the primary backing and loop backs 16.

The non-skid polymer layer 20 also preferably includes a flexibilizer. The flexibilizer comprises a thermoplastic elastomer, a thermoplastic rubber, a contained-geometry catalyzed low-density polyethylene, ethylene methyl acrylate, ethylene vinyl acetate, ethylene butyl modified polyethylene or mixtures thereof. Thermoplastic elastomer (TPE) compounds combine the functional performance and properties of conventional thermoset rubbers with the processability of thermoplastics. TPEs permit fabrication of “rubber-like” articles with the speed, efficiency, and economy of injection molding, extrusion, or blow molding. TPEs include, but are not limited to, polyester copolymers, styrene copolymers and olefinics. The amount of flexibilizer relative to the amount of thermoplastic polymer is 0% to 90% by weight of the polymer resin; preferably, 20% to 60% by weight of the polymer resin.

TABLE 1

| | | Typically |
|---|---|---|
| Polymer | Range | (% by weight) |
| LDPE | 0-100% | 0% |
| LLDPE | 0-100% | 0% |
| Thermoplastic | 0-100% | 0% |
| Polyurethane | | |
| Ethylene Vinyl Acetate | 0-100% | 0% |
| Polypropylene | 0-100% | 20-80% |
| Metallocene PE | 0-100% | 20-60% |
| Melt Index <20 | | |
| Specific Gravity <0.88 | | |
| Metallocene PE | 0-100% | 30-40% |
| Melt Index >20 | | |
| Specific Gravity <0.90 | | |
| EPDM | 0-100% | 20-80% |
| Fillers | 0-90% | 30% |

The present invention provides improved bundle encapsulation/penetration, stitch/fiber lock, wet tuft bind, lamination strength, dimensional stability and moisture barrier. The backing's resistance to water and liquid penetration makes the backing non-dyeable during the dyeing process, which is an important advantage of the present invention as it results in a clean, functional, non-skid backing. The superior moisture barrier properties keep liquids and spills from penetrating the backing, meaning easier clean up, faster drying times and reduced mold and mildew problems.

In the process of the present invention, a flexible, non-skid coating is made through the use of extrusion compounding, whereby the raw materials are compounded in-line through and compounding extruder, such as a co-rotating twin screw extruder, for example a Model No. ZSK57W-50P extruder manufactured by Werner-Pfleiderer, Stuttgart, Germany. Compounded resins can be extruded directly to the back of a textile through a slot die. Alternately, after the resins are compounded through the extruder, the compounded resins can be cut into pellets and distributed to customers for processing. These pre-cut pellets can then be passed through either a single or multiple screw extruder regardless of the rotational direction of the screw or screws, so as to create varying shear possibilities or combinations.

During the compounding process, additives can be added into the resin to give added properties or features to the coating. These additives can be added as a single addition or combined with other additives to achieve the desired properties of the extruded coating. Such additives can be precisely metered into the extruder mechanism through one or more injection ports on the extruder such that such additive materials are thoroughly mixed with the polymer resin being process through the extruder. The ability to inject predetermined amounts or predetermined ratios of one or more additives to polymer resins being processed in an extruder is well known in the art.

For example, fillers, such as Portland cement, calcium carbonate, barites, fly ash and other inorganic material, can be added to the resins to lower costs. Such fillers can be used in amounts of 0% to approximately 90% by weight of the polymer resin. Stearic acid can be added to the fillers during the extrusion process to react and create dispersants, such as magnesium stearate and calcium stearate, that will assist in dispersing the fillers into the resin and also aids in the rheology and viscosity of the extruded resin by creating more even distribution of the filler in the resin during the extrusion process.

Flame retardant fillers or flame retardant additives, such as magnesium hydroxide or aluminum trihydrate, can also be added to the resin during extrusion. Such flame retardant fillers or flame retardant additives can be added in amounts of approximately 0% to 90% by weight of the polymer resin.

Antimicrobial additives can be added to help control mold and mildew growth in wet environments. Such antimicrobial additives can be added in amounts of approximately 1% to 10% by weight of the polymer resin. Also, scents or odor eliminators can be added to the resin. Such scents or odor eliminators can be added in amounts of approximately 1% to 15% by weight of the polymer resin.

Depending on the desired physical properties of the finished bath mat or scatter rug, other materials can be incorporated into the coating during extrusion to achieve the desired effect, while maintaining the performance of the coating.

If it is desired to form a foam coating instead of an elastomeric coating, blowing agents can be added to the resin during the extrusion process. Such blowing agents expand in the molten resin, thereby creating a foamed backing for the bath mat or scatter rug. Either a gaseous blowing agent, such as Expancel or a chemical blowing agent, such as Wil-Foam, which is commercially available from Akzo Nobel can be used. The blowing agents can be metered into the resins during compounding thereof through an injection port on the extruder mechanism. Such blowing agents can be added in amounts of approximately 0.1% to 10% by weight of the polymer resin.

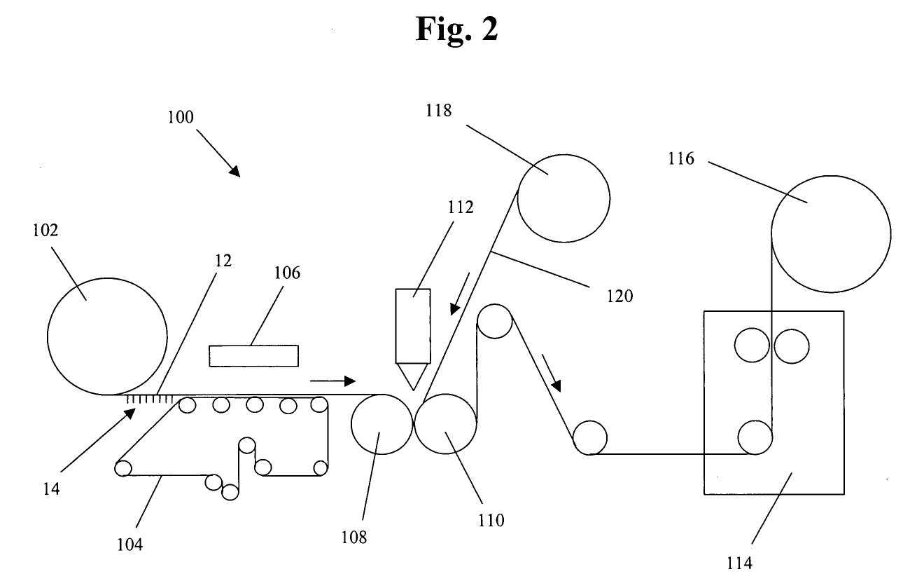

With reference to FIG. 2, it will be seen that there is disclosed an apparatus 100 for making the floor covering product 10 shown in FIG. 1. The process for making the floor covering product 10 comprises feeding the griege textile product or facing layer 18; i.e., the tufted primary backing 12 having a downwardly extending face pile 14, from a supply roll 102 onto a conveyor belt 104. An infrared heater 106 disposed above the primary backing 12 preheats the tufted primary backing. The infrared heater 106 preheats the tufted primary backing 12 to a temperature of approximately 150° to 300° F.

The preheated tufted primary backing 12 then proceeds from the infrared heater 106, over the nip roller 108 and under the nip roller 110, so that the preheated tufted primary backing passes between the predetermined space between the nip rollers. Disposed above the nip rollers 108, 110 is a twin-screw co-rotating extruder 112. The composition for the non-skid, thermoplastic polymer coating is fed to the extruder 112 where it is mixed and extruded through a slot die (not shown) so as to form a sheet or film of molten coating material. The extruder 112 is positioned so that the sheet or film of molten coating material is applied to the back surface of the primary backing material 12 just prior to entering the space between the nip rollers 108, 110. The extruder 112 extrudes the coating material at a temperature of approximately 250° to 500° F.

The nip rollers 108, 110 are water heated to a temperature of approximately 70° to 200° F. Furthermore, the space between the nip rollers 108, 110 is set so that pressure is applied to the coated primary backing 12 of greater than approximately 100 pounds per linear inch. Passing the coated primary backing 12 between the heated nip rollers 108, 110 levels the non-skid coating into a layer of desired thickness and also forces the non-skid coating into the fibers of the primary backing and the loop backs 16. Adjustment of the pressure applied by the nip rollers 108, 110 can be controlled to achieve the desired amount of penetration of the non-skid, thermoplastic polymer coating into the primary backing 12 and the amount of bundle encapsulation and stitch/fiber lock.

The coated primary backing 12 then proceeds from the nip roller 110 to the roll-up station 114 where it is rolled up into a roll 116. The roll 116 can then be transferred to a cutting station (not shown) where the roll of textile material can be cut into desired sizes and shapes.

Optionally, it may be desirable to add additional structural layers to the floor covering product 10 to improve physical properties, such as dimensional stability. Therefore, it is contemplated that one or more additional layers can be incorporated into the backing of the floor covering product 10. Such structural layer can be comprised of either woven or non-woven: glass, fiberglass, polypropylenes, polyesters, nylons, or mixtures thereof regardless of whether woven or non-woven. These structural layers can be totally encapsulated in the non-skid, thermoplastic polymer coating or partially embedded in the non-skid, thermoplastic polymer coating.

With further reference to FIG. 2, it can be seen that a supply roll 118 of a structural material, such as nonwoven fiberglass 120, is optionally provided. The layer of nonwoven fiberglass 120 is introduced to the primary backing 12 by simultaneously feeding the nonwoven fiberglass into the space between the nip rollers 108, 110. The molten coating composition and the pressure from the nip rolls 108, 110 laminates the fiberglass 120 to the primary backing 12. Depending on the amount of non-skid, thermoplastic polymer coating material applied to the primary backing 12 and the pressure of the nip rollers 108, 110, the fiberglass 120 can be either partially embedded in the non-skid, thermoplastic polymer layer 18 or completely encapsulated therein. Optionally, the composite of the tufted primary backing and the laminated fiberglass layer 120 can be run through the apparatus 100 a second time so that an additional layer on the non-skid, thermoplastic polymer can be applied to the back surface of the fiberglass layer.

The following example is intended to illustrate the present invention, but is not intended to limit the scope of the present invention in any manner.

### EXAMPLE 1

A floor covering product 10 comprising a primary backing 12 of polypropylene tufted with nylon a cut pile 14 is provided. The non-skid, thermoplastic polymer coating composition that is fed into the extruder 112 is shown in Table 2 below.

TABLE 2

| Ingredient | Amount (% by weight) |
|---|---|
| ExxonMobil 1703 Vistalon | 70% |
| Polypropylene | |
| ExxonMobil Achieve 6936G1 EPDM | 30% |
| Akzo Nobel Perkadox BC-40K PD | 1% |
| Peroxide | |

The non-skid, thermoplastic polymer formulation shown in Table 2 above has a softening temperature of approximately 215° F.

For the formulation shown above in Table 2, the process parameters shown in Table 3 below are used.

TABLE 3

| Process Parameter | Value |
|---|---|
| Preheat temperature | 220° F. |
| Extruder type | 28 mm co-rotating twin screw |
| Extrusion temperature | 400° F. |
| Nip roller temperature | 80° F. |
| Nip roller pressure | 110 pounds per linear inch |
| Non-skid coating weight | 16 oz per square yard |

The floor covering material is processed as described above using the apparatus shown in FIG. 2. The finished product is cut into the size and shape of a scatter rug.

The scatter rug is washed in a conventional residential washing machine and dried in a conventional residential tumble drying machine at a temperature of approximately 160° F. The scatter rug is then examined for damage and dimensional changes, but none are found.

It is specifically contemplated that the non-skid, thermoplastic polymer coating of the present invention is washable and dryable in conventional residential washing and drying machines. Such residential drying machines dry textile materials at temperatures of between approximately 100° and 200° F. As used herein the term “dryable” means that the non-skid, thermoplastic polymer coating on the textile material, such as bath mats and scatter rugs, will not change size or shape by more than 10% at temperatures up to 200° F. In accordance therewith, it is specifically contemplated that the non-skid, thermoplastic polymer preferably has a softening temperature of greater than approximately 200° F.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A washable and dryable floor covering comprising:
a textile material; and
a non-skid, thermoplastic polymer coating on a surface of the textile material, said non-skid, thermoplastic polymer having a softening temperature of greater than approximately 200° F.

2. A method of making a washable and dryable floor covering comprising:
applying to a surface of a textile material a non-skid, thermoplastic polymer, said non-skid, thermoplastic polymer being applied directly to said textile material in a molten state;
applying pressure to said textile material and molten non-skid, thermoplastic polymer on said textile material, so that said molten non-skid, thermoplastic polymer adheres to said textile material; and
said non-skid, thermoplastic polymer coating having a softening temperature of greater than approximately 200° F.
